(19) United States
(12) Patent Application Publication
(10) Pub. No.: US 2016/0171546 A1
(43) Pub. Date: Jun. 16, 2016

(54) Situation Aware Travel Information

(71) Applicant: Fly Fleet LLC, Fairfax, VA (US)

(72) Inventors: Daniel Gartenberg, Washington, DC (US); Robert J. Youmans, Campbell, CA (US); Octavian Geagla, Boulder, CO (US); Vincent Paul Spinella-Mamo, Boca Raton, FL (US); Melissa Smith, Fairfax, VA (US)

(21) Appl. No.: 14/568,944

(22) Filed: Dec. 12, 2014

(51) Int. Cl. G06Q 30/02; G06Q 50/30; H04W 4/02

(52) U.S. Cl. CPC G06Q 30/0261; H04W 4/021; G06Q 50/30; G06Q 30/0269

(57) ABSTRACT

A system for providing a user with situational information. A user state is defined by information specific to a user, such as location and physiological state of the user, (e.g. fatigue). A travel state is defined by information regarding a transportation service, for example delayed or on time. A geo-location state is determined by the user's location. Situational information is displayed to the user based on the user state, the travel state, and any relevant merchants that are nearby the user. This may include information about the transportation, merchants, or advertisements. The user state may also include sensor data from at least one wearable sensor located on the user. The user state may be aggregated from multiple users to determine congestion, predict emergency situations, and provide alternative routes.

### CROSS REFERENCE TO RELATED APPLICATIONS

This application claims the benefit of the filing date under 35 USC 119(e) of provisional applications entitled “Method and device to determine pedestrian congestion” Ser. No. 61/916,174, filed on Dec. 14, 2013 and “Situation Aware Travel Information”, Ser. No. 62/030,938, filed Jul. 30, 2014, the entire contents of which is fully incorporated herein by reference.

### FIELD OF THE INVENTION

The present disclosure generally relates to a system for providing travelers situational information. More particularly, the present disclosure relates to a system that can identify a user's state and travel scenario and display information to the user based upon these factors. In addition, the system is able to aggregate data from multiple users to determine conditions such as congestion based on the locomotion data of the user state.

### BACKGROUND OF THE INVENTION

When travelling, especially through an airport, travelers may sometimes find themselves delayed, or with cancelled transportation. Further, the stress of getting through the check-in processes and security lines adds to the overall traveler displeasure.

When an unfortunate traveler finds himself or herself in a delayed situation the traveler may become upset or uneasy. These delay situations differ based on the stage of the traveler's progress, the extent of the delay, and the travel environment. Longer delays and missed flights can cause more anxiety—and in these situations—the traveler is more likely to explore their environment. However, if there is no delay and the traveler is on time, the traveler is less likely to seek out information in their environment.

Merchants located near the traveler can lose out on potential transactions with the traveler in situations where the traveler is more likely to want to make a purchase when the traveler's progress, the extent of the delay, and the travel environment are not taken into account. When these factors are not taken into account, the appropriate information about the merchants may not reach the traveler. For example, if it has been detected that the traveler has sufficient time to make a merchant purchase because their flight has recently been delayed, but the traveler is not aware of the merchant's proximity or how long the merchant transaction will last—information about the merchant can be made available to the traveler.

Airlines and air travel companies can predict these delays (e.g. mechanical reasons, weather, etc.); however, there is currently no robust way to ascertain delays caused by pedestrian traffic. Congestion at airports, malls, amusement parks, or other establishments caused by pedestrians can result in frustration and delays, or missed flights. This congestion cannot be detected, as there is no way of non-invasively measuring the user state of travelers as they navigate different phases of their journey.

What is desired is a system to more effectively present travelers with relevant information, determined by various aspects of travel information, such as flight delays, boarding status, temperature, time of day, and the like, as well as information about the user, such as, the likelihood of hunger, anxiety, fatigue, boredom, and other affective physiological variables, and geo-location data in order to provide the user with information, advertisements, or deals in response to the various combinations of these travel information. Furthermore, the system should also use the information collected from multiple users to provide such information as congestion, based on the locomotion data.

### SUMMARY OF THE INVENTION

The basic inventive concept is a system for providing situational information to a user based upon a travel state, a user state, and a geo-location state and further aggregating multiple users' user states to determine congestion.

A first aspect of the present invention provides a system including a non-transitory computer readable medium having instructions that, when executed, cause one or more processors to perform the following steps: determine the travel state of a user; determine a predicted geo-location state of the user; determine a user state; identify at least one geo-location relevant merchant to the user; and present situational information to the user about each geo-location relevant merchants based on the travel state, user state, and geo-location state.

In another aspect of the invention, the travel state is at least one from the group comprising delayed transportation, canceled transportation, on-time transportation, departed transportation, arrived transportation, history of the transportation, and the congestion at the transportation site.

In yet another aspect of the invention, the user state is defined by at least one from the group comprising: the user has not left for the travel location, the user is traveling to the travel location, the user is at the travel location, the user is some distance from the travel location, the user is transferring between travel locations, and the user is at the travel destination.

In a further aspect of the invention, the situational information is at least one from the group comprising a deal, an advertisement, information about the geo-location relevant merchant, and general information about the airport environment, wherein presenting the situational information comprises transmitting the information to the user's smartphone, personal digital assistant, tablet, or computer in the form of an audio-visual display.

In another aspect of the invention, an amount of available time is calculated based on the travel state and the user state and an extent of a deal or advertisement is selected based on the amount of available time.

In yet another aspect of the invention, the user state further comprises physiological data, either input from the user directly or queried from a database, wherein at least one piece of the physiological data is selected from the group comprising user fatigue data, user boredom data, user stress data, user hunger data, user weather conditions data, user destination location data, and user locomotion state data.

In a further aspect of the invention, every piece of physiological data is determined by at least one from the group comprising survey data, body motion data, heart-rate data, duration of journey data, amount of available time, perspiration data, oxygenation data, hormone level data, delay data, and time of day data, wherein each datum is collected from a sensor worn by the user and transmitted to the at least one processor.

In another aspect of the invention, the geo-location state is defined by at least one from the group comprising a predicted ticketing location of the user, a predicted departing position of the user, a predicted arriving position of the user, a predicted baggage claim location of the user, and a predicted security checkpoint of the user; wherein if the geo-location state comprises more than one from the group, the geo-location state further comprises a predicted path between each of the elements selected from the group.

In a further aspect of the invention, the geo-location state is determined by at least one of the group comprising querying a global positioning system, querying a local wireless positioning system, querying a vision based location system, calculating body motion data of the user, and querying a database.

In yet another aspect of the invention, the situational information is further based on at least one selected from the group comprising demographic information about the user, the user's previous interactions with the presented situational information, and how long a transaction takes at the geo-location relevant merchant.

In another aspect of the invention, the situational information presented is selected by a third party who has been shown at least one from the group comprising the user state, the geo-location relevant merchants, the travel state, and the geo-location state.

In a further aspect of the invention, the user interaction with the situational information is used to predict the user state.

In yet another aspect of the invention, a system is provided for determining pedestrian congestion including a non-transitory computer readable medium containing instructions that, when executed by one or more processors, cause the one or more processors to collect locomotion data from a user; detect a pattern of locomotion data from the user to determine a user state; calculate an onset and an offset of a user state to determine a contextual state of the user; filter the contextual state of a user to determine proxy data that describes the relationship between the user state data and a filter; predict probability of a pattern of the proxy data; and provide information in the form of audio-visual alerts to relevant individuals based on the predicted probability.

In a further aspect of the invention, the locomotion data is acquired from a locomotion sensor which is at least one selected from the group comprising accelerometer measurements, gyroscope measurements, and actigraphy data.

In another aspect of the invention, the pattern of locomotion data is selected from the group comprising walking, running, waiting in line, riding a roller coaster, beginning to wait on-line, exiting a line, riding in a vehicle, and going through security.

In yet another aspect of the invention, the system provides at least one of a suggestion for an alternative route, a probability of the user missing their destination, the extent of a delay, travel location congestion, or an emergency situation.

In another aspect of the invention, the filtering of the contextual state can be obtained using at least one of GPS data that describes the location of the user, GPS data that describes the distance between users, user input data, and check-in time data.

In another aspect of the invention, the proxy data can be combined based on historical trends of the location and historical trends of the user in such a manner that the alerts provided to the relevant individual may be a predicted value of congestion at a future time and location.

In a further aspect of the invention, a system is provided for determining activity transitions including a non-transitory computer readable medium containing instructions that, when executed by one or more processors, cause the one or more processors to: collect locomotion data from a user; detect a pattern of locomotion data from the user to determine a user state; determine a transition from one pattern of locomotion data to another; filter the transition to determine proxy data; and provide information in the form of audio-visual alerts to relevant individuals based on the proxy data.

In yet another aspect of the invention, the pattern of locomotion data is at least one selected from the group comprising riding a roller coaster, beginning to wait on-line, exiting a line, riding in a vehicle, and going through security.

In a yet another aspect of the invention, the pattern of locomotion data is the locomotion sensor passing along a conveyor belt.

In another aspect of the invention, the pattern of locomotion data is at least one selected from the group comprising riding a roller coaster, beginning to wait on-line, exiting a line, riding in a vehicle, and going through security.

These and other advantages of the invention will be further understood and appreciated by those skilled in the art by reference to the following written specification, claims and appended drawings.

### BRIEF DESCRIPTION OF THE DRAWINGS

The invention will now be described, by way of example, with reference to the accompanying drawings, where like numerals denote like elements and in which:

FIG. 1 presents a graphical overview of the system to provide information to a user based on a user state, a travel state, and geo-location state;

FIG. 2 presents a flow diagram of the steps which the system performs;

FIG. 3 presents a flow diagram of the steps the system performs, highlighting that the steps can be performed simultaneously;

FIG. 4 presents an alternative embodiment of the system in which information is presented to a third party;

FIG. 5 depicts a pedestrian using the system;

FIG. 6 presents a pictorial representation of a calculation of wait time;

FIG. 7 presents a flow diagram for providing aggregated data; and

FIG. 8 presents a flow diagram of an alternative embodiment of the invention in which the aggregated data is used to predict emergency events.

Like reference numerals refer to like parts throughout the various views of the drawings.

### DETAILED DESCRIPTION OF THE INVENTION

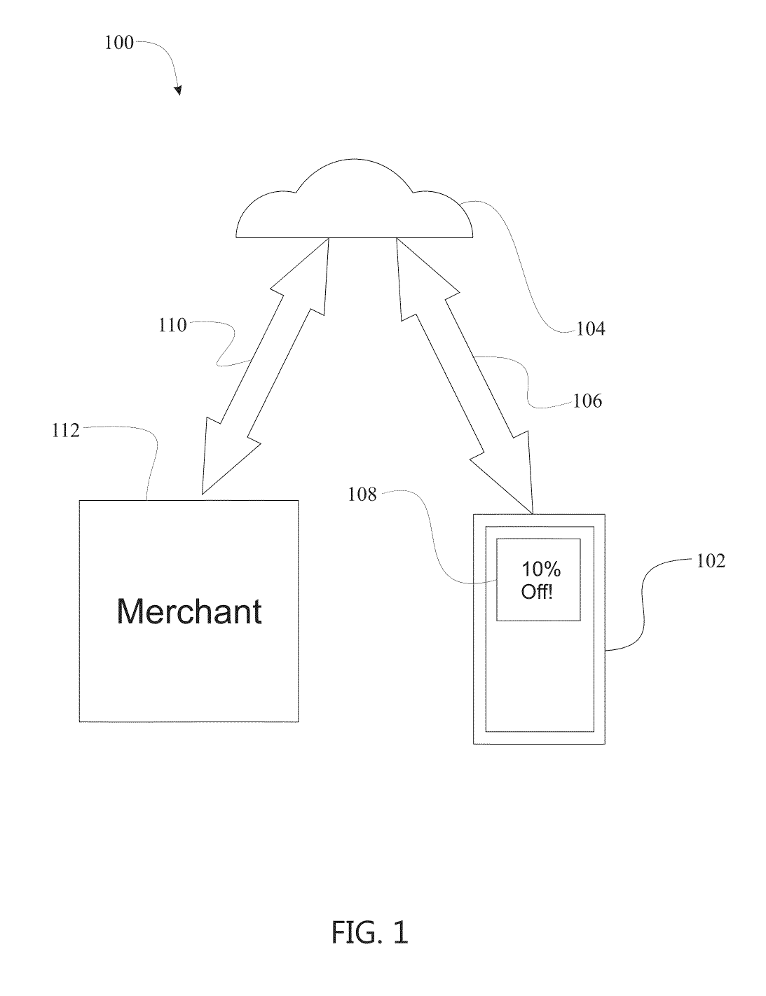

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

A system 100 is described for collecting a user state, a travel state, and a geo-location state in order to display situational information to a user. Turning first to FIG. 1, an overall pictorial representation of the system 100 is shown. Generally, a mobile device 102 communicates with a cloud-based server 104 to provide a user's user state, travel state, and geo-location state to the cloud-based server 104. The cloud-based server 104 curates situational information, provided by a merchant 112, based on the user state, the travel state and the geo-location state of the user. A merchant 112 may also be in communication with the cloud-based server 104 to provide content of the situational information. The merchant 112 may be a store, restaurant, coffee shop, bar, museum, amusement park attraction, or any other location where a user may interact.

More specifically, the mobile device 102 communicates with the cloud-based server 104 over a wireless data transfer mechanism 106. For exemplary purposes, the wireless data transfer mechanism may be a radio frequency network. The mobile device 102 may be a smart phone. A display area 108 is located on the mobile device 102. The display area 108 is able to display situational information, which is provided by the cloud-based server 104. The mobile device 102 is also capable of querying information from the user. This information may include travel information, such as flight number and departure time, as well as personal information including, but not limited to, age and gender. The travel information may include a travel location, which is the geographic location of the place of departure, a travel destination, which is the geographic location of the place of arrival. The mobile device 102 may use the information queried from the user to determine the travel location and the travel destination. Alternatively, this information may be retrieved by the cloud-based server 104 by accessing various services which provide that data. The mobile device 102 may also query the user for additional user information, which includes the user's level of fatigue, boredom, stress, and hunger, or for delay information and destination location. The mobile device 102 may query either the user or a separate server for the user's geo-location, locomotion state, and weather conditions. Alternatively, weather information may be retrieved by the cloud-based server 104 querying a weather service. A user state is then defined as some combination of the following: the user has not left for a travel location, the user is traveling to a travel location, the user is at a travel location, the user is transferring between travel locations, and the user is at a travel destination. The user state may also be defined by the additional user information.

Additional physiological data about the user may be gathered through at least one sensor on the mobile device 102, to further define the user state. For exemplary purposes, the sensor may be a heart-rate monitor, hormone level detector, perspiration detector, an accelerometer, a clock, or a pulse oximetry device, which determine heart-rate data, hormone level data, perspiration data, body motion data, time of day data, and oxygenation data, respectively. These sensors may be used to provide the mobile device 102 with additional information about the user state. For example, a user with a high stress level may exhibit high hormone levels, especially cortisol, greater perspiration, increased body motion, and an increased heart rate, whereas a user with low stress would not exhibit any of the aforementioned characteristics. Since all of the above data varies with the time of day, the time of day data may be used to adjust the measured values based on normal ranges for particular times. For example, heart-rate is usually lower in the morning than it is in the middle of the day, so a heart-rate associated with stress may be lower in the morning than it is in the evening. The variation of normal levels with time of day is similarly exhibited with the other data.

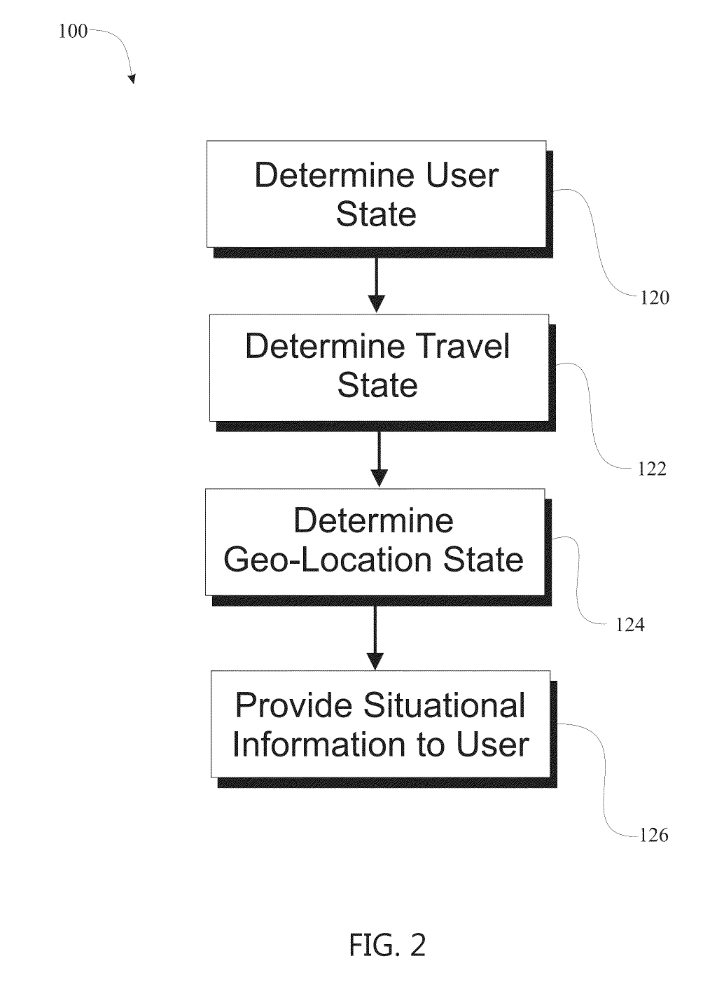

The system is depicted in flow chart form in FIG. 2. In a user determination step 120, a user state is determined. As above, the user state may be defined as some combination of the following: the user has not left for the travel location, the user is traveling to the travel location, the user is at the travel location, the user is transferring between travel locations, and the user is at the travel destination. The user state may also contain additional information, whether queried by the mobile device 102 or acquired by at least one sensor on the mobile device 102. For instance, if a user is running late for a flight, the user state may be “the user is travelling to the travel location, has a heart rate of 110, is stressed, and is hungry”. Another example may be if a user is at their gate for a flight, it is lunchtime, and the flight has been delayed, the user state may be “the user has plenty of available time at the gate location and is hungry”.

In a travel determination step 122, a travel state is determined. The travel state generally defines a state that the travel service provider is in. The travel state may be determined in the cloud-based server 104. For exemplary purposes only, if the user is travelling by air, the cloud-based server 104 may query a service provided by an airline, which generates flight data based on a flight number, which is given by the user. The travel state may be “delayed transportation”, “on-time transportation”, or “canceled”, although these may vary based on the mode of transportation used. In the event that the travel state is “delayed transportation”, the travel state also includes the length of the delay.

In a geo-location determination step 124, a geo-location state of a user is determined. The geo-location may be determined by the mobile device 102 querying the user. The geo-location state is defined as being a predicted ticketing location, a predicted departing gate of the user, a predicted arriving gate of the user, a predicted baggage claim location of the user, and a predicted security checkpoint of the user. The data is referred to as predicted, as the location may change at any point before actual departure occurs. The geo-location state may be assessed based on either data queried directly from the user via the mobile device 102, or by either the mobile device 102 or the cloud-based server 104 performing a query on a third party service. For example, if the user is flying on an airline, web based services exist which are able to provide gate information, baggage check information, security information, and ticketing location based upon a flight number, departure time, and departure location. Additionally, the geo-location state may be determined using additional sensors located on the mobile device 102. For exemplary purposes, the geo-location state may also include latitude and longitude coordinates using a GPS (global positioning system) sensor, however it may include data from other sensors, such as proximity sensors or inertial measurement units (IMUs). The IMUs can be used to calculate body motion data for use in specifying position. Especially in indoor environments, alternative sensors which provide geo-location must be used. Several examples include wireless network based SLAM (simultaneous localization and mapping), visual SLAM/position estimation techniques, as well as wireless position indicators (such as iBeacon), although various other mechanisms exist to determine location in a GPS-less environment.

Once a state is determined, it is communicated from the mobile device 102 to the cloud-based server 104 over the wireless data transfer mechanism 106. For exemplary purposes, all states may be encoded into a common transmission schema, such as JSON or XML. Once the cloud-based server 104 has determined the user state, the travel state, and the geo-location state, a situational query is performed on a database of all the information provided by all merchants 112. The response of the query is situational information. In a display step 126, the situational information is sent over the wireless data transfer mechanism 106 to the mobile device 102 and displayed on the display area 108. The situational query may be performed repeatedly at any particular frequency and will continuously update the situational information which is relayed to the user. For example, the situational query may be run every 5 minutes, or whenever the cloud-based server 104 detects a change in the user state, the travel state, or the geo-location state. The mobile device 102 may be constantly querying for all states, or may be set to query for the states at a particular frequency.

At least one merchant 112 is able to communicate with a cloud-based server 104 over communication mechanism 110, in order to upload situational information. Each merchant 112 provides situational information such as merchant locations, potential deals, advertisements, and other information about the merchant 112. Other information each merchant 112 uploads may include the items that the merchant 112 sells, store hours, and contact information. All situational information provided by all merchants 112 is stored on a database on the cloud-based server 104. The merchant 112 is also able to change settings on the cloud-based server 104 which change the response of the situational query. For example, the merchant 112 may configure the cloud-based server to vary an extent of a deal based on a user state indicating stress, where the extent of a deal is how much the merchant 112 is offering. As a particular example, the merchant 112 may configure a larger percent discount for those users who have a higher level of stress.

Additionally, the cloud-based server 104 is able to calculate an amount of available time. The amount of available time is defined as the difference between the current time and a time of departure. The time of departure may be provided based either by querying the user or the cloud-based server 104 querying a web based service. For example, the time of departure for a flight may be provided by an airline by a query of the flight number. Each merchant 112 is also able to use the amount of time available as a setting for tailoring the extent of the deal. Further, the cloud-based server may use the geo-location state to only select those merchants 112 which are within a specified proximity of the user and are defined as geo-relevant merchants.

The cloud-based server 104 may also return information to the user which is independent of any merchant 112. For example, the cloud-based server 104 may perform a query based on the travel state and the user state to determine if the user has missed transportation. Missed transportation may also be indicated by an amount of available time less than or equal to zero. If the user state is “is travelling to the travel location” and the travel state is “departed transportation”, the user has missed transportation and the cloud-based server 104 may send that information to the mobile device 102. The user may also query the cloud-based server 104 directly, via the mobile device 102, for other information, such as general airport information or merchant information. General airport information may include location of bathrooms, merchants 112, telephones, and gate information. The query response may be limited by the geo-location state. For example, a user may query the cloud-based server 104 for all of the nearby bathrooms. As a similar example, the user may query the cloud-based server for all of the nearby merchants 112 that sell magazines.

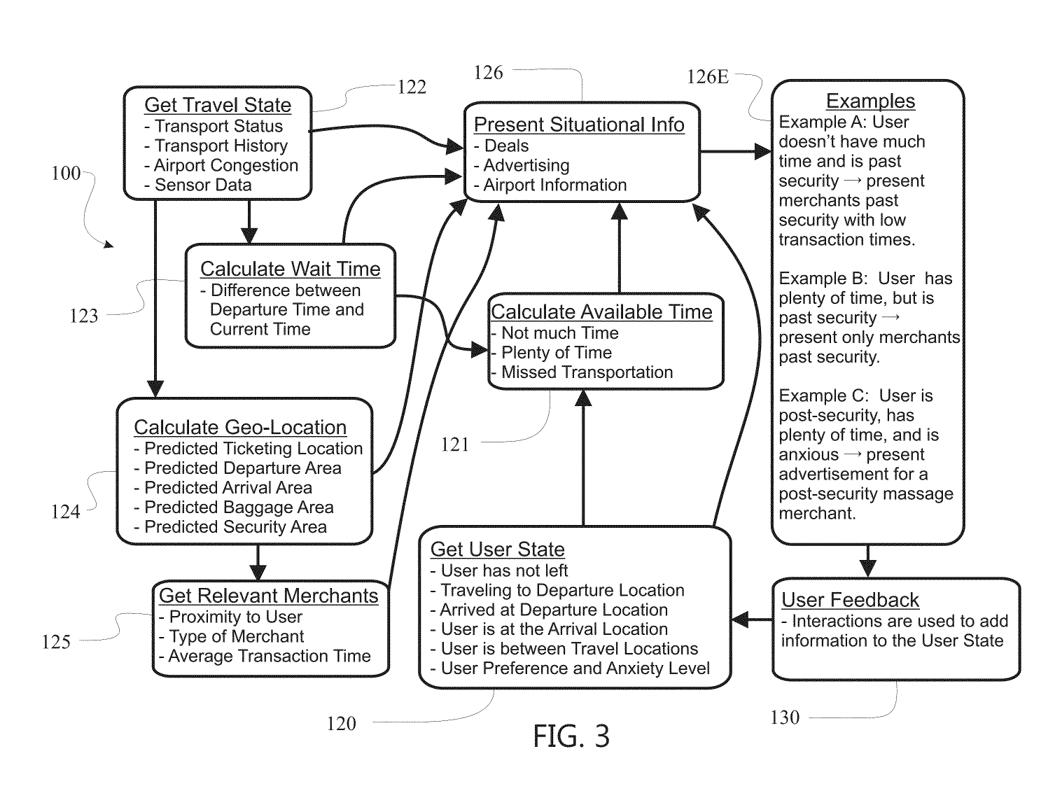

Although the depiction of the system performing the steps shown in FIG. 2 is linear, this is merely for exemplary purposes. As shown in FIG. 3, all of the steps performed as shown in FIG. 2 can be performed simultaneously. The travel determination step 122, user state determination step 120, and geo-location determination steps are all independently performed before the display step 126. FIG. 3 also shows several intermediate steps including a calculate wait time step 123, a calculate-available-time step 121, and a get relevant merchants step 125. In the calculate wait time step 123, a wait time is calculated as a difference between a departure time and a current time. In the calculate-available-time step 121, the wait time is divided into three categories: not much time, plenty of time, and missed transportation. In the get relevant merchants step 125, merchants are selected via a database query which are close to the user in proximity, are of a specific type (e.g. restaurant, coffee shop, or the like), and the average transaction time taken at that merchant. Example output 126E highlights several scenarios and the resulting situational information that may be created based on the various inputs to the display step 126. Other examples of the situational information presented, include: if the user has plenty of time and is on their way to the airport, include merchants that are prior to security that take a long amount time, such as a sit-down restaurant, if the user has plenty of time because the flight has been delayed and the user is post security, present a deal for a post security merchant that takes a long amount of time, and if a transportation has been cancelled and the user is at the geo-location, present a deal for an alternative transportation available at the geo-location of the travel. In addition, FIG. 3 shows that in a user feedback step 130, any responses the user has to the situational information presented is fed back into the system into the user state determination step 120 in order for the system to use that information in future display steps 126.

For exemplary purposes, the following illustrates a typical scenario in which a user could employ the present invention. A user purchases an airline ticket. Prior to departure, the user enters the flight information into the mobile device 102 and the current position of the user is detected. The information is then sent to the cloud-based server 104. The cloud-based server 104 then queries additional information about the user state and the travel state. For instance, the flight information may indicate a travel state of “on-time” and a geo-location state of “departs from Gate A3”. When the user arrives at the gate, the user state is changed to “at the travel location” and the geo-location state is changed to “predicted gate location”. The change of these states may be determined by a query of the user or by some positioning system. The cloud-based server 104 then calculates the amount of available time and performs the situational query based on the user state, the travel state, and the geo-location state to determine the situational information to return to the user. As the user arrives very early to the airport, the amount of available time indicates that there is sufficient time for the user to sit down for a meal. The situational information displayed on the mobile device 102 is as follows: “10% off dinner at Restaurant A located at Gate A5”, “5% drink special at Bar X located between Gate A4 and A5”, and “$1.00 off of coffee at Coffee House”. As the user continues to wait, the cloud-based server 104 continually performs situational queries. When there is only 15 minutes before departure, the situational information which is displayed is now, “$2.00 off of coffee at Coffee House”.

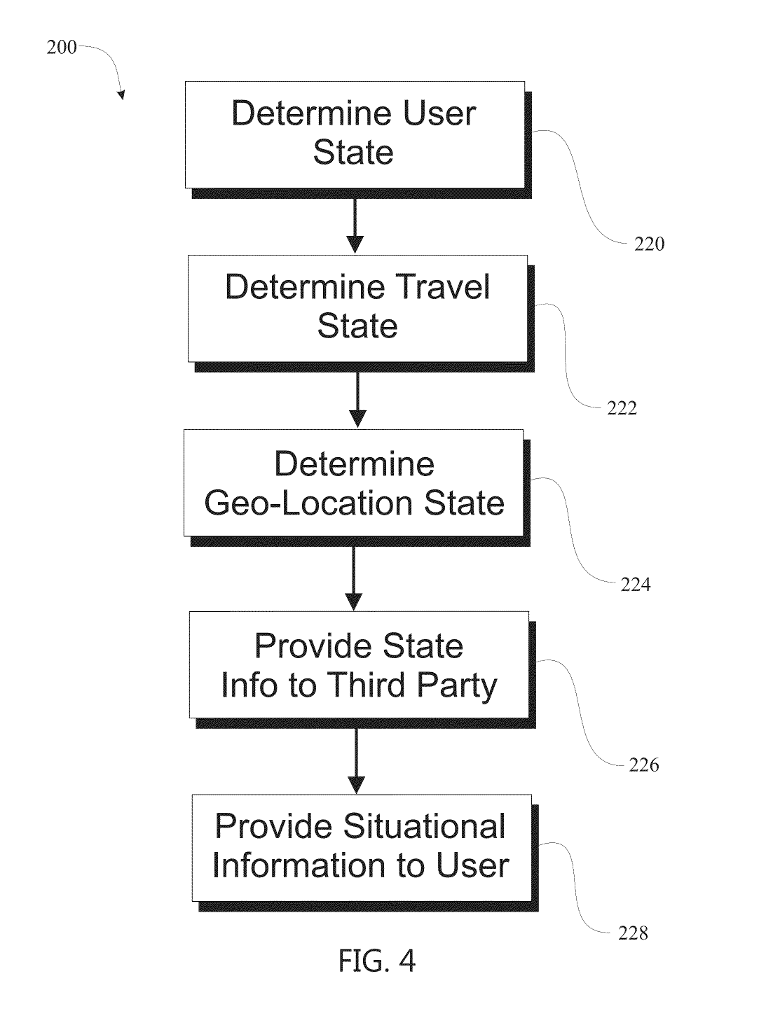

A second embodiment is depicted in FIG. 4. Here, as in the previous embodiment, a user state, a travel state, and a geo-location state is determined from a user in a user state determination step 220, a travel state determination step 222, and a geo-location determination step 224, respectively. The user state, the travel state, and the geo-location state are then transmitted to the cloud-based server 104. These states are then made available for any third party to view in a selection step 226. The cloud-based server 104 may only display the information if the third party correctly provides login information or a special code which is unique to the user. The third party may then select the situational information that is to be transmitted to the user based on the user state, travel state, and geo-location state of the user. The cloud-based server 104 then transmits this situational information to the mobile device 102 in a providing step 228. For exemplary purposes, the third party may select to send a gift certificate to the user for a restaurant near the user's geo-location state if the user state is “at the travel location and hungry” and the travel state is “delayed transportation”.

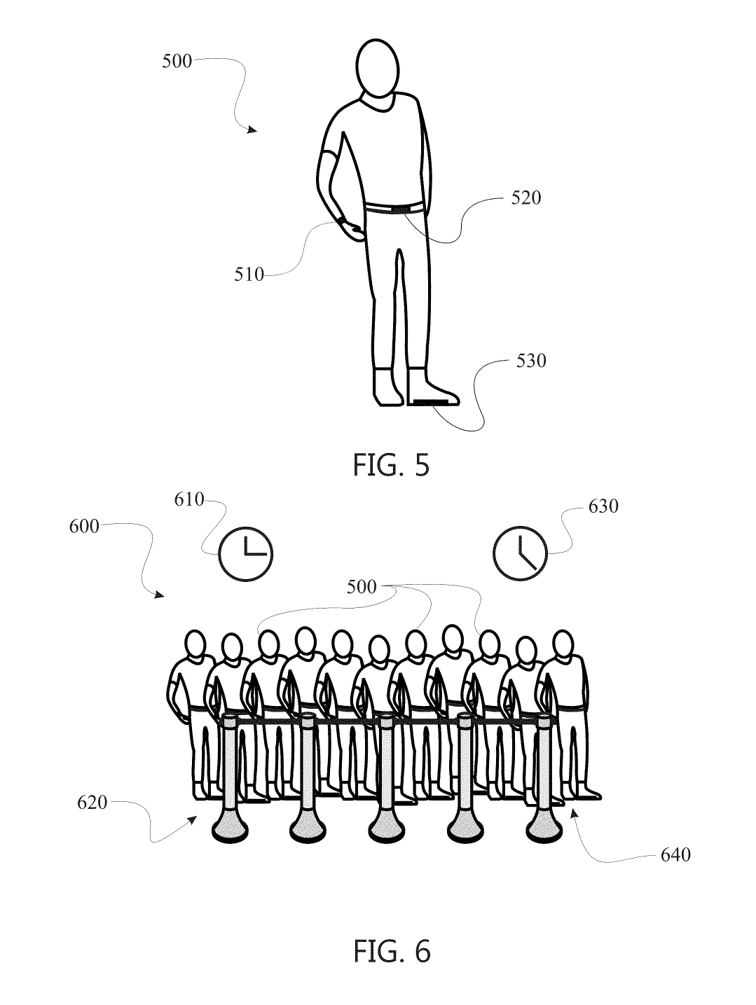

Pedestrian congestion may also play a significant factor in determining how to plan for travel. The invention contemplates aggregating user data to infer pedestrian congestion. FIG. 5 shows a pedestrian 500. In order to collect locomotion data about the pedestrian 500, the system requires at least one sensor to be placed about the pedestrian's 500 body. For exemplary purposes, the pedestrian 500 may be wearing a wrist sensor 510, a belt sensor 520, or a shoe sensor 530, although other locations are contemplated. The sensors may also be those that are normally contained in a mobile device 102, which is carried in a pocket of the pedestrian 500. These sensors may be at least one of a GPS, an accelerometer, and a gyroscope. The sensors are able to communicate over a wireless network the locomotion data acquired from the at least one sensor to the cloud-based server 104. The cloud-based server 104 then detects a pattern of locomotion from the locomotion data to determine a user state. When the pattern of locomotion begins and ends signify an onset and an offset of a user state, respectively. The onset and offset of a user state defines a contextual state. For example, the contextual state may be “waiting in line.” The contextual state is then filtered to determine proxy data that describes the relationship between the contextual data and a filter. For example, a filter may be “at a 3:00 pm and at the airport,” which, when coupled to the user state of “waiting in line” would return all pedestrians 500 which are “waiting in line at 3:00 pm at the airport.” If a significant number of users were returned, the proxy data would indicate “pedestrian congestion.” Another filter, or query, may be performed where the query is based on absolute user GPS location, or GPS location relative to other users. The response to this query also defines proxy data and may indicate pedestrian congestion or an emergency state. Alternatively, the cloud-based server 104 may receive information directly input by the pedestrian 500 indicating that the pedestrian 500 is observing a particular proxy data (e.g. pedestrian congestion). The proxy data is stored and used to predict a probability of a pattern of the proxy data at any time and place requested. Finally, the cloud-based server 104 provides information in the form of audio-visual alerts to relevant individuals based on the predicted probability. For exemplary purposes, a person planning on traveling to an airport in an hour would be displayed different alerts based on the probability of pedestrian traffic at the airport one hour from now (e.g. if the probability of the proxy data was a high likelihood of pedestrian congestion, the cloud-based server 104 would transmit a message stating: “Leave Early, High Probability of Pedestrian Congestion!”).

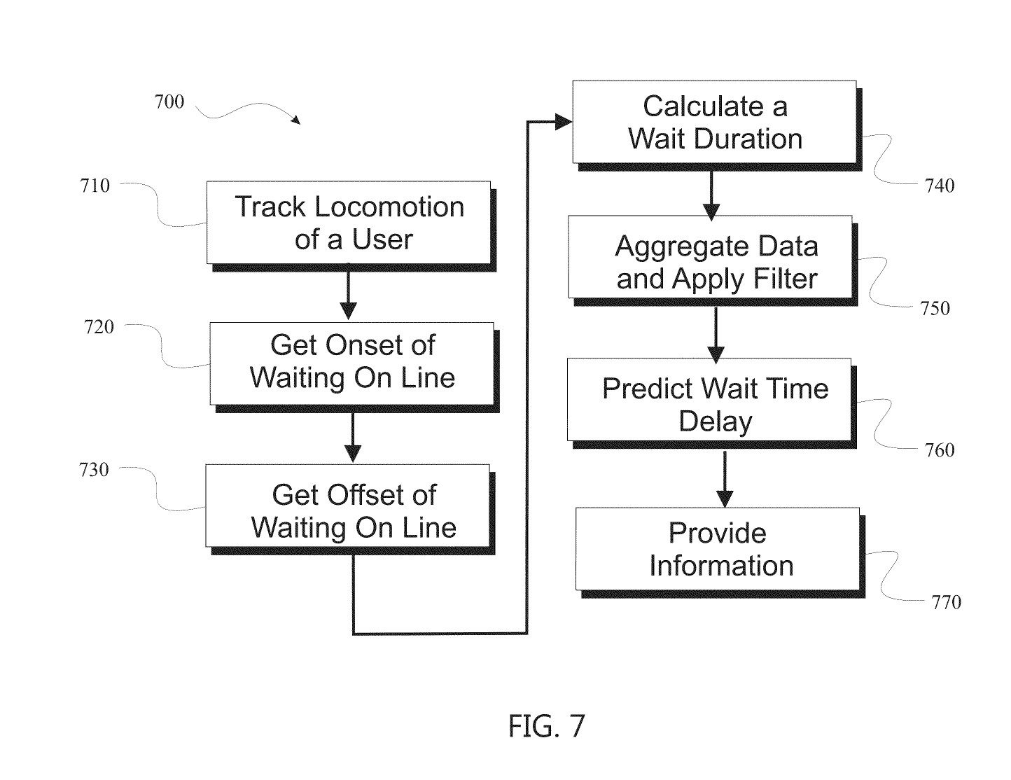

In an alternative embodiment, shown in FIGS. 6 and 7. The wrist sensor 510, belt sensor 520, or shoe sensor 530 can be used to determine if the pedestrian 500 is waiting in line. When a pedestrian 500 enters a line at an entrance point 620 and an entrance time 610, sensor values provided by the mobile device 102, wrist sensor 510, belt sensor 520, or shoe sensor 530 change. For example, any variations in accelerometer values should reduce upon the transition to a standing or waiting mode from a more active mode. The entrance time 610 is recorded in an onset step 720. Similarly at an exit point 640 and exit time 630, the sensor values change in a complimentary manner, increasing in variation. Changes in sensor values, such as in the previous example, can be determined using some machine learning algorithm to predict patterns of locomotion. In a wait time step 740, a difference between the exit time 630 and the entrance time 610 is computed and stored. In a filtering step 750, the difference can be filtered based on items such as GPS, i.e. selecting only those events which correspond to a particular location. This data is combined with a specific GPS location or space in time in order to determine the overall contextual state of the user. Multiple contextual states of users are then combined using a filter that can be based on GPS location, user input, check-in information, or other means to determine overall group contextual state. In a prediction step 760, a query may be performed based on historical data and trends to make a prediction on congestion at a particular geographic location and place in time. Using the information provided in the prediction step 760, the amount of time may be provided to other pedestrians 500 in a display step 770, as well as rerouting options.

In an alternative embodiment, it is contemplated to provide a combination of audio or visual alerts based on transitions from pattern of locomotion to another. For example, in the event that a mobile device 102 is placed on a conveyer belt to pass through security, there is a unique transition in the signals which are sensed and transmitted by the sensors in the mobile device 102. Other locomotion patterns contemplated are driving, riding in an amusement park ride, waiting in line, or exiting a line. The sensor signals are collected by the cloud-based server 104 which determines them to be of some specific pattern (e.g. on a conveyer belt), and then filtered, as before. The result of the filtered signals are used to send a specific series of audio-visual alerts. A time of the transition may also be recorded in the cloud-based server 104 to enable adjusting of the alerts transmitted. For example, a pedestrian 500 may place his or her mobile device 102 onto a conveyer belt. Once the transition has been detected from “being on a conveyer belt” to some other state, the cloud-based server 104 may transmit an audio-visual signal to the pedestrian 500, or any other party, announcing and displaying “Good Job Getting Through Security!”

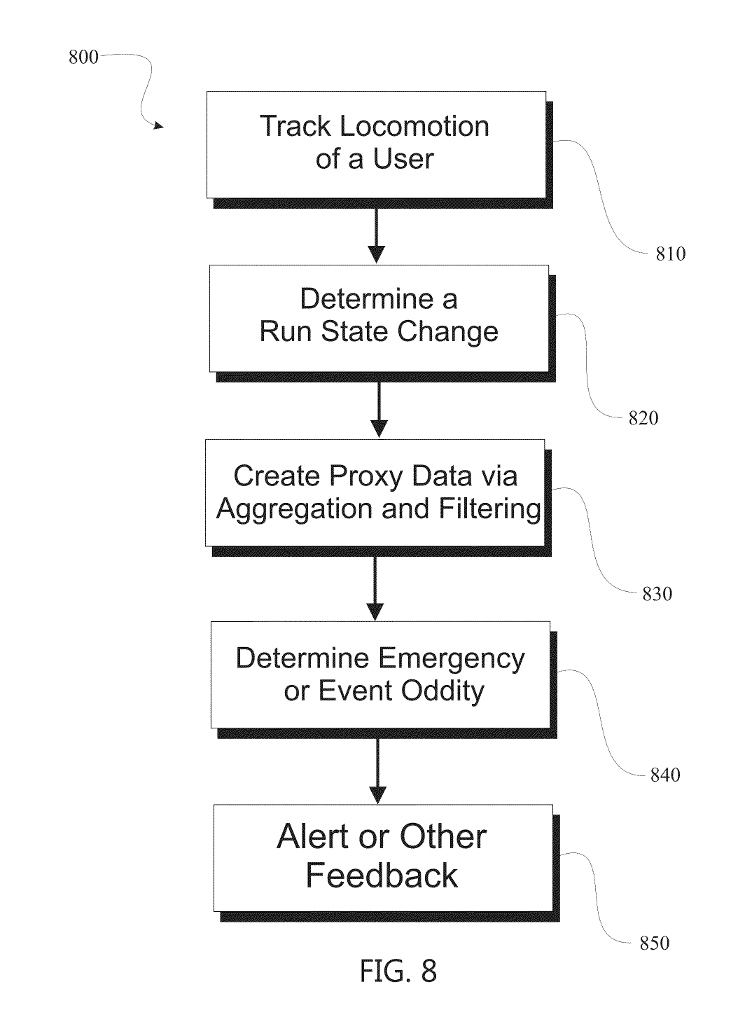

Turning now to FIG. 8, the system can be used to detect emergency events in real-time in an emergency state detection mode 800. An emergency event is detected when multiple users change from a walking or waiting state to a running state. In order to detect this, user states are first tracked in a tracking step 810. A query can be performed on the system to return the user state for all users in located in a particular geo-location (e.g. using the GPS position). In a determination step 820, a ratio of users in a user state that indicates “running” to the number of users in the user state that indicates “walking”, or stationary, can be tracked over time. Walking, running, and stationary states can be determined based on accelerometer, GPS, or gyroscopic instantaneous values. For example, a stationary state may be determined where a low pass filtered value of the accelerometer is nearly constant. Once that ratio passes a threshold, an emergency situation is specified. For example, a threshold of 10% can be used to monitor a location that generally has slow pedestrian traffic, such as a mall. In another example, it may be desirable to set a higher threshold, 50%, in areas where running is common, such as parks and playgrounds. If an emergency situation is detected, a message is broadcast to all users, as well as to emergency personnel. While a GPS based query is one example of a filter, other filters which combine multiple contextual states of users may include user input, check-in information, or other methods to filter the overall group contextual state.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What I claim is:

1. A system for providing a user with situational information including a non-transitory computer readable medium having instructions that, when executed, cause one or more processors to perform the following steps:
determine a travel state of a user;
determine a predicted geo-location state of the user;
determine a user state;
identify at least one geo-location relevant merchant to the user; and
present situational information to the user about each geo-location relevant merchants based on the travel state, user state, and geo-location state.

2. The system according to claim 1, wherein the travel state is at least one from the group comprising: delayed transportation, canceled transportation, on-time transportation departed transportation, and arrived transportation.

3. The system according to claim 1, wherein the user state is defined by at least one from the group comprising:
the user has not left for the travel location,
the user is traveling to the travel location,
the user is some distance from the travel location,
the user is at the travel location,
the user is transferring between travel locations, and
the user is at the travel destination.

4. The system according to claim 1, wherein the situational information is at least one from the group comprising a deal, an advertisement, information about the geo-location relevant merchant, and general information about the airport environment, wherein presenting the situational information comprises transmitting the information to the user's smartphone, personal digital assistant, tablet, or computer in the form of an audio-visual display.

5. The system according to claim 1, wherein an amount of available time is calculated based on the travel state and the user state and an extent of a deal or advertisement is selected based upon the amount of available time.

6. The system according to claim 3, wherein the user state further comprises physiological data, either input from the user directly or queried from a database, wherein at least one piece of the physiological data is selected from the group comprising:
user fatigue data,
user boredom data,
user stress data,
user hunger data,
user weather conditions data,
user destination location data, and
user locomotion state data.

7. The system according to claim 6, wherein each piece of physiological data is determined by at least one from the group comprising survey data, body motion data, heart-rate data, duration of journey data, amount of available time, perspiration data, oxygenation data, hormone level data, delay data, and time of day data, wherein each datum is collected from a sensor worn by the user and transmitted to the at least one processor.

8. The system according to claim 1, wherein the geo-location state is defined by at least one from the group comprising:
a predicted ticketing location of the user,
a predicted departing position of the user,
a predicted arriving position of the user,
a predicted baggage claim location of the user, and
a predicted security checkpoint of the user;
wherein if the geo-location state comprises more than one from the group,
the geo-location state further comprises a predicted path between each of the elements selected from the group.

9. The system according to claim 8, wherein the geo-location state is determined by at least one of the group comprising querying a global positioning system, querying a local wireless positioning system, calculating body motion data of the user, querying a vision based location system, and querying a database.

10. The system according to claim 1, wherein the situational information is further based on at least one selected from the group comprising demographic information about the user, the user's previous interactions with the presented situational information, and how long a transaction takes at the geo-location relevant merchant.

11. The system according to claim 1, wherein the situational information presented is selected by a third party who has been shown at least one from the group comprising the user state, the geo-location relevant merchants, the travel state, and the geo-location state.

12. A system for determining pedestrian congestion including a non-transitory computer readable medium containing instructions that, when executed by one or more processors, cause the one or more processors to:
collect locomotion data from a user;
detect a pattern of locomotion data from the user to determine a user state;
calculate an onset and an offset of a user state to determine a contextual state of the user;
filter the contextual state of a user to determine proxy data that describes the relationship between the user state data and a filter;
predict a probability of a pattern of the proxy data; and
provide information in the form of audio-visual alerts to relevant individuals based on the the predicted probability,
wherein the proxy data may be queried from the user.

13. The system of claim 12, wherein the locomotion data is acquired from a locomotion sensor which is at least one selected from the group comprising accelerometer measurements, gyroscope measurements, and actigraphy data.

14. The system according to either claim 13, wherein the pattern of locomotion data is selected from the group comprising walking, running, waiting in line, riding a roller coaster, beginning to wait on-line, exiting a line, riding in a vehicle, and going through security.

15. The system according to claim 12, wherein the system provides at least one of a suggestion for an alternative route, a probability of the user missing their destination, the extent of a delay, travel location congestion, or an emergency situation.

16. The system according to claim 12, wherein the filtering of the contextual state can be obtained using at least one of GPS data that describes the location of the user, GPS data that describes the distance between users, user input data, and check-in time data.

17. The system according to either claim 13, wherein the proxy data can be combined based on historical trends of the location and historical trends of the user in such a manner that the alerts provided to the relevant individual may be a predicted value of congestion at a future time and location.

18. A system for determining activity transitions including a non-transitory computer readable medium containing instructions that, when executed by one or more processors, cause the one or more processors to:
collect locomotion data from a user;
detect a pattern of locomotion data from the user to determine a user state;
determine a transition from one pattern of locomotion data to another;
filter the transition to determine proxy data; and
provide information in the form of audio-visual alerts to relevant individuals based on the proxy data.

19. The system of claim 18, wherein the pattern of locomotion data comprises at least one selected from the group comprising riding a roller coaster, beginning to wait on-line, exiting a line, riding in a vehicle, and going through security.

20. The system of claim 18, wherein the pattern of locomotion data is the locomotion sensor passing along a conveyor belt.
